(19) United States
(12) Patent Application Publication
(10) Pub. No.: US 2014/0159688 A1
(43) Pub. Date: Jun. 12, 2014

(54) METHOD OF MAINTAINING AN OUTPUT VOLTAGE OF A POWER CONVERTER

(71) Applicant: Microsemi Corporation, Alsio Viejo, CA (US)

(72) Inventor: Arkadiy PEKER, Glen Cove, NY (US)

(73) Assignee: Microsemi Corporation, Alsio Viejo, CA (US)

(21) Appl. No.: 14/094,816

(22) Filed: Dec. 3, 2013

Related U.S. Application Data
(60) Provisional application No. 61/735,625, filed on Dec. 11, 2012.

(51) Int. Cl. H02M 3/156

(52) U.S. Cl. CPC H02M 3/1563
USPC 323/282

(57) ABSTRACT

A method of operating a power converter so as to maintain an output voltage, the method constituted of: receiving an input voltage; generating the output voltage from the input voltage responsive to at least one electronically controlled switch in communication with an inductor; deriving a gate voltage for the at least one electronically controlled switch of the power converter from the received input voltage; and deriving a gate voltage for the electronically controlled switch from the output voltage in place of the derived gate voltage from the input voltage responsive to a predetermined condition of one of the received input voltage and the generated output voltage.

### TECHNICAL FIELD

The invention relates generally to the field of power converters and more particularly to a power converter arranged to alternately derive its gate voltage from one of the input voltage and the output voltage.

### BACKGROUND

The power for both the control circuitry and the electronically controlled switches of power converters are usually derived from the input voltage of the power converter. Disadvantageously, in the event of a drop in the input voltage the power converter will cease operating immediately. The output voltage can be used for deriving power for the control circuitry and electronically controlled switches of the power converter, however the output voltage is not always sufficient for such a task, particularly during the initiation of the power converter. Various strartup circuits are also known which provide initial power until the power converter is able to produce output power, and then continue to supply a low power via a dedicated spare transformer winding, however in the event that the input power fails, the dedicated spare transformer winding ceases to supply power to run the power converter, despite the existence of output power supported by the power converter output capacitor.

### SUMMARY OF THE INVENTION

Accordingly, it is a principal object of the present invention to overcome the disadvantages of prior art power converters. Particularly, a method of operating a power converter so as to maintain an output voltage is provided, the method comprising: receiving an input voltage; deriving a gate voltage for an electronically controlled switch of the power converter from the received input voltage; converting the received input voltage to generate the output voltage responsive to operation of the electronically controlled switch; and deriving a gate voltage for the electronically controlled switch from the output voltage responsive to a predetermined condition of one of the received input voltage and generated output voltage.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1A illustrates a high level schematic diagram of a power converter arranged to maintain an output voltage regardless of a drop in the input voltage of the power converter;

FIG. 1B illustrates a high level schematic diagram of an embodiment of a VCC selection circuitry;

FIG. 2 illustrates a high level flow chart of a method of maintaining an output voltage of a power converter responsive to a predetermined condition of one of said received input voltage and generated output voltage; and

FIGS. 3-6 each illustrate a high level flow chart of particular predetermined conditions of the method of FIG. 2.

### DETAILED DESCRIPTION OF THE PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

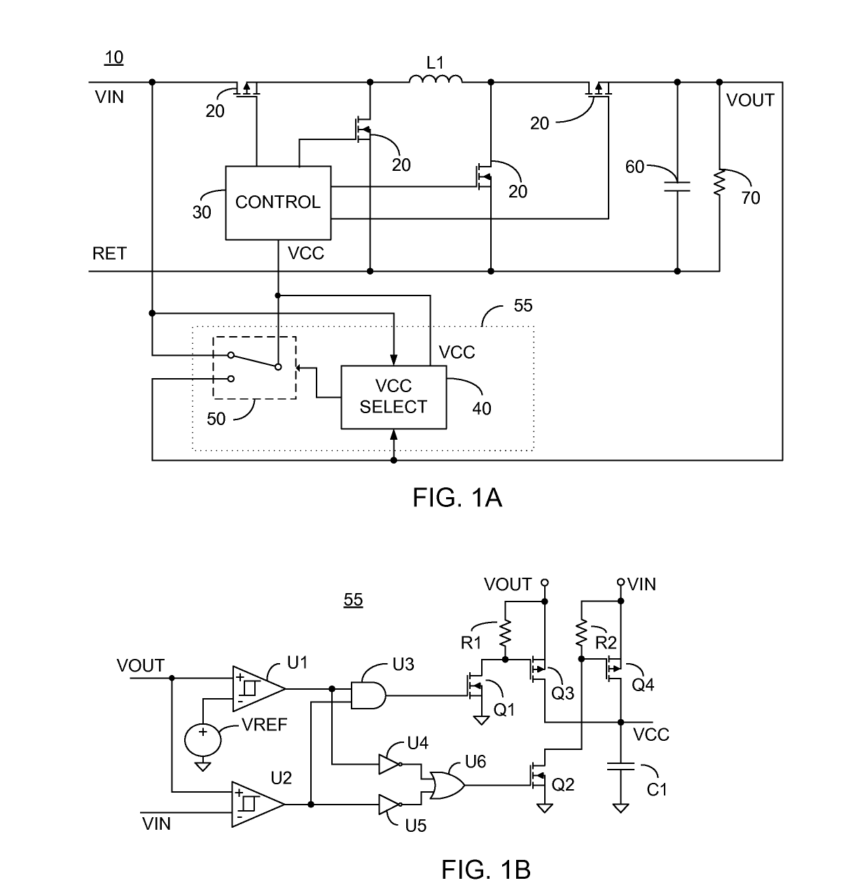

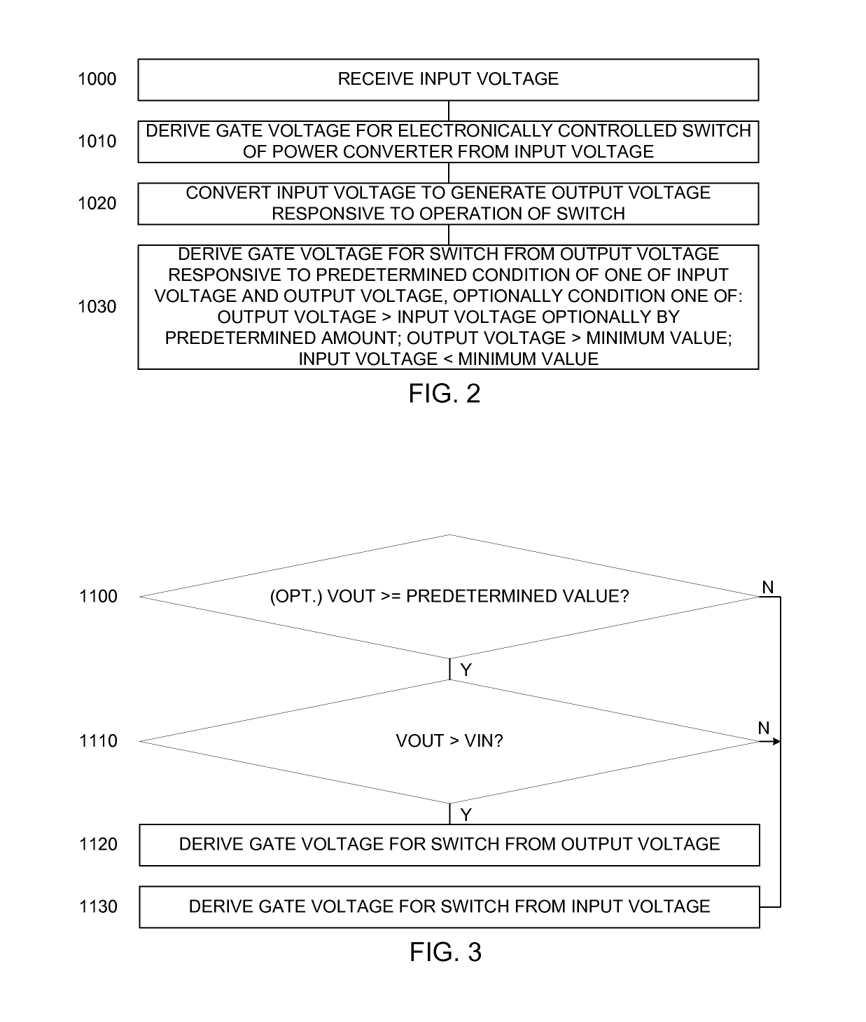

FIG. 1A illustrates a high level schematic diagram of a power converter 10 arranged to maintain an output voltage regardless of a drop in its input voltage, power converter 10 comprising: a first, second, third and fourth electronically controlled switch 20; a control circuitry 30; a VCC selector 40; a voltage selection voltage selection switch 50; a capacitor 60; a impedance 70; and an inductor L1. First and fourth electronically controlled switches 20 are each illustrated as being implemented as a p-channel metal-oxide-semiconductor field-effect transistor (PFET), however this is not meant to be limiting in any way and any type of electronically controlled switch can be provided without exceeding the scope. Second and third electronically controlled switches 20 are each illustrated as being implemented as a n-channel metal-oxide-semiconductor field-effect transistor (NFET), however this is not meant to be limiting in any way and any type of electronically controlled switch can be provided without exceeding the scope. Voltage selection switch 50 is in one non-limiting embodiment implemented as a single pole, double throw (SPDT) switch. Each of control circuitry 30 and VCC selector 40 can be implemented by one or more of: a state machine; a microcontroller; a field programmable gate array (FPGA); and dedicated analog circuitry, without limitation. VCC selector 40 is advantageously implemented by simple “glue” logic and thus utilizes minimal power in relation to the power needs of control circuitry 30. The combination of VCC selector 40 and voltage selection switch 50 are further denoted VCC selection circuitry 55. It is to be understood that the implementation of VCC selection circuitry 55 by the combination of VCC selector 40 and voltage selection switch 50 is meant to explain the logic of operation, and the implementation of VCC selection circuitry is not limited to such an implementation. In particular, as described below, in certain embodiments a simple diode OR circuit, with, or without, and undervoltage lockout circuit may be provided for VCC selection circuitry 55 without exceeding the scope.

The drain of first electronically controlled switch 20 is coupled to an input of power converter 10, denoted VIN, and the gate of first electronically controlled switch 20 is coupled to a particular output of control circuitry 30. The source of first electronically controlled switch 20 is coupled to a first end of inductor L1 and to the drain of second electronically controlled switch 20. The gate of second electronically controlled switch 20 is coupled to a particular output of control circuitry 30 and the source of second electronically controlled switch 20 is coupled to a return of power converter 10, denoted RET. A second end of inductor L1 is coupled to the drain of each of third electronically controlled switch 20 and fourth electronically switch 20. The gate of third electronically controlled switch 20 is coupled to a particular output of control circuitry 30 and the source of third electronically controlled switch 20 is coupled to RET. The gate of fourth electronically controlled switch 20 is coupled to a particular output of control circuitry 30 and the source of fourth electronically controlled switch 20 is coupled to a first end of capacitor 60 and to a first end of impedance 70, to a first input of VCC selector 40 and to a first terminal of voltage selection switch 50, the junction denoted VOUT and represents the output of power converter 10. A second end of each of capacitor 60 and impedance 70 are coupled to RET. The pole of voltage selection switch 50 is coupled to a power input of control circuitry 30, the input denoted VCC, and similarly to a VCC input of VCC select 40, if required. Input VIN is further coupled to a second terminal of voltage selection switch 50 and to a second input of VCC selector 40.

Power converter 10 is illustrated as a buck-boost converter, however this is not meant to be limiting in any way. In another embodiment, power converter 10 can be provided as any other type of power converter, such as a buck converter or a boost converter, without exceeding the scope. The gate voltage for each of first, second, third and fourth electronically controlled switches 20 are provided by control circuitry 30 derived from VCC. Control circuitry 30 may be implemented by any buck-boost control circuitry as known to those skilled in the art.

In operation, initially the output of VCC selector 40 is arranged such that voltage selection switch 50 is positioned such that VIN is coupled to the VCC input of control circuitry 30 and control circuitry 30 is arranged to control first, second, third and fourth electronically controlled switches 20 utilizing VIN as the supply voltage. VCC selector 40 is arranged to control voltage selection switch 50 utilizing VIN as the supply voltage, if such power is required. As known in the art of power converters, in an inductor charging mode second and fourth electronically controlled switches 20 are opened and first and third electronically controlled switches 20 are closed, thereby charging inductor L1. In an inductor discharging mode, first and third electronically controlled switches 20 are opened and second and fourth electronically controlled switches 20 are closed thereby transferring the energy stored in inductor L1 to capacitor 60. Impedance 70 represents the output load which draws power responsive to VOUT. Capacitor 50 maintains VOUT betweens cycles of charging and discharging modes, and further maintains VOUT for a predetermined period, responsive to the load value of impedance 70, after VIN falls below a predetermined minimum dropout value.

VCC selector 40 is arranged to control the connection of voltage selection switch 50 such that VOUT is coupled to the VCC input of control circuitry 30, responsive to a predetermined condition of one of VIN and VOUT. Control circuitry 30 is then arranged to control first, second, third and fourth electronically controlled switches 20 utilizing VOUT as the supply voltage VCC. There is no requirement that VOUT directly provide VCC, and regulators or voltage dividers may be supplied to adjust the value of VOUT so as to provide a desired VCC without exceeding the scope. Additionally, VCC selector 40 is arranged to control voltage selection switch 50 utilizing a VCC derived from VOUT as the supply voltage.

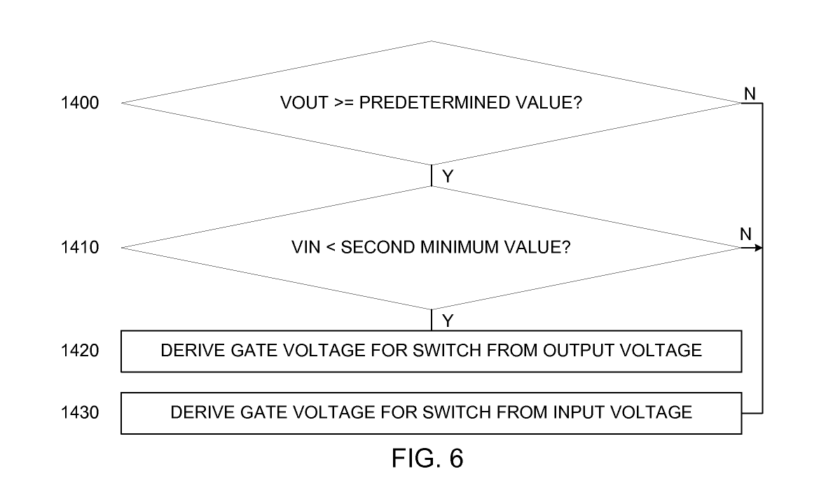

In one embodiment, as will be described below in relation to FIG. 3, the predetermined condition is when VOUT is greater than VIN. In one further embodiment, as will be described below in relation to FIG. 4, the predetermined condition is when VOUT is greater than VIN by a predetermined amount. In another embodiment, as will be described below in relation to FIG. 5, the predetermined condition is when VOUT is greater than a first predetermined minimum value. In another embodiment, as will be described below in relation to FIG. 6, the predetermined condition is when VIN is less than a second predetermined minimum value. voltage selection switch 50

In the event that voltage selection switch 50 is positioned such that VIN is coupled to the input of control circuitry 30 and the predetermined condition is not met, VCC selector 40 is arranged to maintain voltage selection switch 50 in the current position, and VCC is derived from VIN. In the event voltage selection switch 50 is positioned such that VOUT is coupled to the input of control circuitry 30 and the predetermined condition is not met, VCC selector 40 is arranged to change the position of voltage selection switch 50 such that VIN is coupled to the VCC input of control circuitry 30, and VCC is derived from VIN. Additionally, VCC selector 40 is arranged to control voltage selection switch 50 utilizing VIN as the supply voltage, i.e. VCC for voltage selection switch 50 is derived from VIN.

The above described operation allows electronically controlled switches 20 of power converter 10 to be initially controlled responsive to VIN and to be thereafter controlled responsive to VOUT. Advantageously, in the event of a drop in VIN the operation of power converter 10 will continue since electronically controlled switches 20 are controlled responsive to VOUT, and capacitor 60 temporarily maintaining a sufficient voltage at VOUT to control electronically controlled switches 20. As described above, voltage selection switch 50 is illustrated as being implemented by an SPDT switch, however this is not meant to be limiting in any way. In another embodiment, voltage selection switch 50 is implemented as a pair of electronically controlled switches, a first of which arranged to couple VIN to the VCC input of control circuitry 30 and the second of which arranged to couple VOUT to the VCC input of control circuitry 30. In such an embodiment, VCC selector 40 is arranged, responsive to the above described predetermined condition, to alternately: close the first electronically controlled switch and open the second electronically controlled switch; and open the first electronically controlled switch and close the second electronically controlled switch.

FIG. 1B illustrates a high level schematic diagram of an embodiment of VCC selection circuitry 55 of FIG. 1A. VCC selection circuitry 55 comprises: a voltage reference source VREF; a first and second hysteretic comparator U1, U2; AND gate U3; first and second inverters U4, U5; OR gate U6; first and second NFETs Q1, Q2; first and second PFETs Q3, Q4; first and second resistors R1, R2 and output capacitor C1.

VOUT is coupled to the non-inverting input of each of first and second hysteretic comparators U1, U2, to the source of first PFET Q3 and to a first end of first resistor R1. VIN is coupled to the inverting input of second hysteretic comparator U2, to the source of second PFET Q4 and to a first end of second resistor R2. The positive output of voltage reference source VREF is coupled to the inverting input of first hysteretic comparator U1, and the return of voltage reference source VREF is coupled to a common potential. The output of first hysteretic comparator U1 is coupled to a first input of AND gate U3 and the input of first inverter U4. The output of second hysteretic comparator U2 is coupled to a second input of AND gate U3 and to the input of second inverter U5. The output of AND gate U3 is coupled to the gate terminal of first NFET Q1, the drain of first NFET Q1 is coupled to a second end of first resistor R1 and to the gate terminal of first PFET Q3. The drain of first PFET Q3 is coupled to output terminal VCC, as described above in relation to FIG. 1A, to the drain of second PFET Q4, and to a first end of output capacitor C1. A second end of output capacitor C1 is coupled to the common potential.

The output of first inverter U4 is coupled to a first input of OR gate U6 and the output of second inverter U5 is coupled to a second input of OR gate U6. The output of OR gate U6 is coupled to the gate terminal of second NFET Q2, and the source of second NFET Q2 is coupled to the common potential. The drain of second NFET Q2 is coupled to the gate of second PFET Q4 and to a second end of second resistor R2.

In operation, when VOUT is greater than VREF and greater than VIN, the output of U3 is asserted, which thus turns on first NFET Q1 and as a result first PFET Q3, thus coupling VOUT to VCC. In the event that VOUT is not greater than VREF, or VOUT is not greater than VIN, the output of OR gate U6 is asserted, which thus turns on second NFET Q2 and as a result second PFET Q4, thus coupling VIN to VCC.

The above implementation of VCC selection circuitry 55 is simply one embodiment of an enabling circuitry, as in not meant to be limiting in any way.

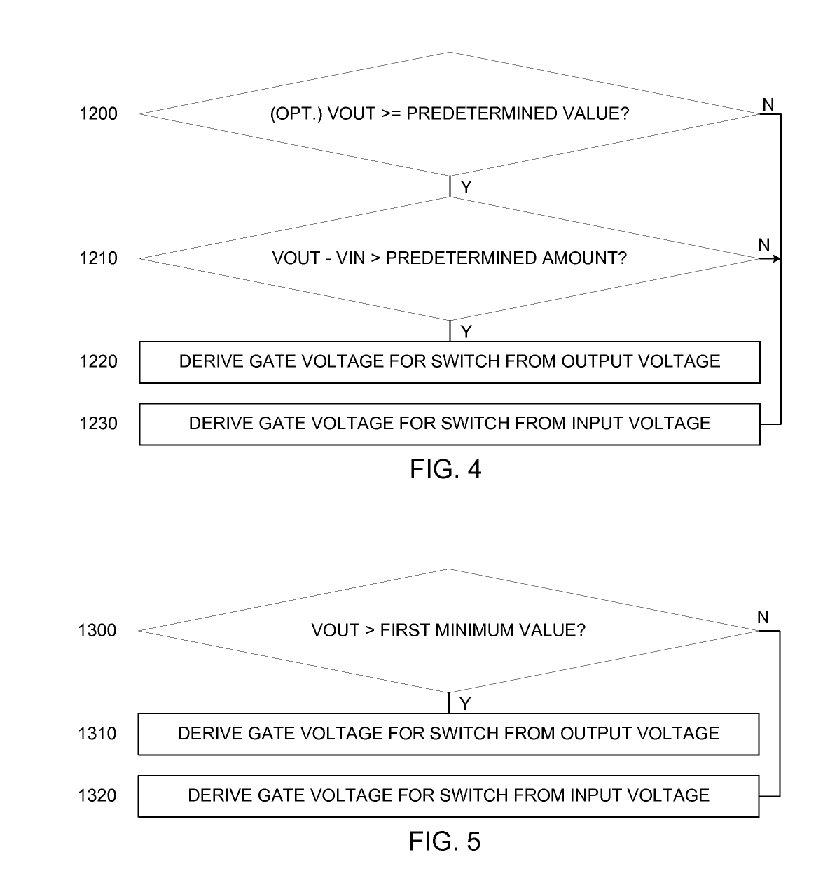

FIG. 2 illustrates a high level flow chart of a method of maintaining the operation of a voltage converter so as to maintain an output voltage of a power converter comprising at least one electronically controlled switch. In stage 1000, an input voltage is received at the power converter, such as VIN. In stage 1010, a gate voltage is derived from the input voltage for the at least one electronically controlled switch of the power converter, such as described above in relation to VCC. In stage 1020, the input voltage is converted to generate an output voltage responsive to the operation of the at least one electronically controlled switch, as known in the art of power converters. In stage 1030, a gate voltage is derived from the output voltage for the at least one electronically controlled switch responsive to a predetermined condition of one of the input voltage and output voltage of the power converter. In one embodiment, as will be described below in relation to FIG. 3, the predetermined condition is where the output voltage is greater than the input voltage. In one further embodiment, as will be described below in relation to FIG. 4, the predetermined condition is where the output voltage is greater than the input voltage by a predetermined amount. In another embodiment, as will be described below in relation to FIG. 5, the predetermined condition is where the output voltage is greater than a first predetermined minimum value. In another embodiment, as will be described below in relation to FIG. 6, the predetermined condition is where the input voltage is less than a second predetermined minimum value. As described above, in one embodiment the gate voltage is developed by control circuitry 30 from VCC, which VCC is derived from one of VIN and VOUT responsive to the predetermined condition.

FIG. 3 illustrates a high level flow chart of a particular embodiment of stage 1020 of FIG. 2. In optional stage 1100, the output voltage of the power converter, denoted VOUT, is compared to a predetermined value. Preferably, the predetermined value is the value of a voltage sufficient enough to be utilized as a supply voltage for a control circuitry arranged to control the at least one electronically controlled switch of stage 1010. In the event that VOUT is greater than, or equal to, the predetermined value, or in the event that optional stage 1100 is not performed, in stage 1110 VOUT is compared to the input voltage of the power converter, denoted VIN. In the event that VOUT is greater than VIN, in stage 1120 a gate voltage is derived from VOUT for the at least one electronically controlled switch of stage 1010. In the event that in stage 1110 it is determined that VOUT is not greater than VIN, or in the event that in optional stage 1100 it is determined that VOUT is less than the predetermined value, a gate voltage is derived from VIN for the at least one electronically controlled switch, as described above in relation to stage 1010. In an embodiment wherein the predetermined value of stage 1100 is a function of the minimum required for operation of the electronically controlled switches 20, advantageously, optional stage 1100 avoids the use of VOUT for deriving a gate voltage for the at least one electronically controlled switch when VOUT is insufficient to close the at least one electronically controlled switch.

FIG. 4 illustrates a high level flow chart of another particular embodiment of stage 1020 of FIG. 2. In optional stage 1200, the output voltage of the power converter, denoted VOUT, is compared to a predetermined value. Preferably, the predetermined value is the value of a voltage sufficient enough to be utilized as a supply voltage for a control circuitry arranged to control the at least one electronically controlled switch of stage 1010. In the event VOUT is greater than, or equal to, the predetermined value, or in the event that optional stage 1200 is not performed, in stage 1210 VOUT is compared to the input voltage of the power converter, denoted VIN. In the event it is determined that VOUT is greater than VIN by a predetermined amount, in stage 1220 a gate voltage is derived from VOUT for the at least one electronically controlled switch. In the event that in stage 1110 it is determined that VOUT is not greater than VIN by the predetermined amount, or in the event that in optional stage 1100 it is determined that VOUT is less than the predetermined value, a gate voltage is derived from VIN for the at least one electronically controlled switch, as described above in relation to stage 1010.

FIG. 5 illustrates a high level flow chart of another particular embodiment of stage 1020 of FIG. 2. In stage 1300, the output voltage of the power converter, denoted VOUT, is compared to a first predetermined minimum value. In the event that VOUT is greater than the first predetermined minimum value, in stage 1310 a gate voltage is derived from VOUT for the at least one electronically controlled switch. In the event that in stage 1300 it is determined that VOUT is not greater than the first predetermined minimum value, a gate voltage is derived from VIN for the at least one electronically controlled switch, as described above in relation to stage 1010.

FIG. 6 illustrates a high level flow chart of another particular embodiment of stage 1020 of FIG. 2. In stage 1400, the output voltage of the power converter, denoted VOUT, is compared to a predetermined value. In the event VOUT is greater than, or equal to, the predetermined value, in stage 1410 the input voltage of the power converter, denoted VIN, is compared to a second predetermined minimum value, optionally being the same value as the first predetermined minimum value of stage 1300 of FIG. 5. In the event that VIN is less than the second predetermined minimum value, in stage 1420 a gate voltage is derived from VOUT for the at least one electronically controlled switch. In the event that in stage 1410 it is determined that VIN is not less than the second predetermined minimum value, or in the event that in stage 1400 it is determined that VOUT is less than the predetermined value, a gate voltage is derived from VIN for the at least one electronically controlled switch, as described above in relation to stage 1010.

Advantageously, the various embodiments of FIGS. 2-6 may enable VCC selector 40 to operate with minimum or no power from VCC at all. For example, FIG. 3 without stage 1100 may be enabled by a simple diode OR arrangement, and stage 1100 may be performed by a under voltage lockout circuit, both of which do not require any power from VCC. Thus, the combination of VCC selector 40 and voltage selection switch 50 may be implemented by a diode OR circuit, with, or without, an undervoltage lockout circuit, without exceeding the scope.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

The terms “include”, “comprise” and “have” and their conjugates as used herein mean “including but not necessarily limited to”.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description.

1. A method of operating a power converter so as to maintain an output voltage, the method comprising:
receiving an input voltage;
generating the output voltage from the input voltage responsive to at least one electronically controlled switch in communication with an inductor;
deriving a gate voltage for the at least one electronically controlled switch of the power converter from said received input voltage; and
deriving a gate voltage for the electronically controlled switch from the output voltage in place of said derived gate voltage from the input voltage responsive to a predetermined condition of one of said received input voltage and said generated output voltage.

2. The method of claim 1, wherein the predetermined condition is when the generated output voltage is greater than the input voltage.

3. The method of claim 1, wherein the predetermined condition is when the generated output voltage is greater than the input voltage by at least a predetermined amount.

4. The method of claim 1, wherein the predetermined condition is when the generated output voltage is greater than a first predetermined minimum value.

5. The method of claim 1, wherein the predetermined condition is when the received input voltage is less than a second predetermined minimum value.

6. A power converter arranged to receive an input voltage and maintain an output voltage, the power converter comprising:
an electronically controlled switch in communication with an inductor, the output voltage generated from the input voltage responsive to the operation of said electronically controlled switch to alternately charge and discharge the inductor;
a control circuitry in communication with said electronically controlled switch and arranged to derive a gate voltage for said first electronically controlled switch from a voltage at a power input of said first control circuitry, said electronically controlled switch switched between and open and closed condition responsive to said first control circuitry derived gate voltage; and
a voltage selection circuitry arranged to to alternately connect the input voltage and the output voltage to the power input of said first control circuitry.

7. The power converter of claim 6, wherein said voltage selection circuitry comprises voltage selector and a voltage selection switch responsive to said voltage selector, wherein said voltage selector is is arranged to control said voltage selection switch to connect the output voltage to the power input of said control circuitry responsive to a predetermined condition of one of the input voltage and output voltage.

8. The power converter of claim 7, wherein the predetermined condition is when the output voltage is greater than the input voltage.

9. The power converter of claim 7, wherein the predetermined condition is when the output voltage is greater than the input voltage by at least a predetermined amount.

10. The power converter of claim 7, wherein the predetermined condition is when the output voltage is greater than a first predetermined minimum value.

11. The power converter of claim 7, wherein the predetermined condition is when the received input voltage is less than a second predetermined minimum value.

12. A power converter arranged to receive an input voltage and maintain an output voltage, the power converter comprising:
a means for receiving the input voltage;
an electronically controlled switch in communication with an inductor, the output voltage of the power converter generated from the received input voltage responsive to the operation of said electronically controlled switch;
a control circuitry in communication with said electronically controlled switch and arranged to derive a gate voltage for said first electronically controlled switch from a voltage at a power input of said first control circuitry, said first electronically controlled switch switched between and open and closed condition responsive to said first control circuitry derived gate voltage;
a means for alternately connecting the input voltage and the output voltage to the power input of said control circuitry.

13. The power converter of claim 12, wherein said means for alternately connecting the input voltage and the output voltage to an input of said control circuitry is responsive to a predetermined condition of one of the input voltage and output voltage.

14. The power converter of claim 13, wherein the predetermined condition is when the output voltage is greater than the input voltage.

15. The power converter of claim 13, wherein the predetermined condition is when the output voltage is greater than the input voltage by at least a predetermined amount.

16. The power converter of claim 13, wherein the predetermined condition is when the output voltage is greater than a first predetermined minimum value.

17. The power converter of claim 13, wherein the predetermined condition is when the received input voltage is less than a second predetermined minimum value.
